(19) United States
(12) Patent Application Publication
(10) Pub. No.: US 2020/0110305 A1
(43) Pub. Date: Apr. 9, 2020

(54) DISPLAY AND DISPLAY PANEL, ARRAY SUBSTRATE THEREOF

(71) Applicants: HKC Corporation Limited, Shenzhen (CN); Chongqing HKC Optoelectronics Technology Co., Ltd., Chongqing (CN)

(72) Inventors: Fengyun Yang, Shenzhen (CN); Entsung Cho, Shenzhen (CN)

(21) Appl. No.: 16/245,370

(22) Filed: Jan. 11, 2019

Related U.S. Application Data
(63) Continuation of application No. PCT/CN2018/114610, filed on Nov. 8, 2018.

(30) Foreign Application Priority Data
Oct. 8, 2018 (CN) 201821630183.5

(51) Int. Cl. G02F 1/1335; G02F 1/1343

(52) U.S. Cl. CPC G02F 1/133553; G02F 1/1343

(57) ABSTRACT

Disclosed is an array substrate, a display panel, and a display. Wherein the array substrate comprises: a substrate and a reflecting electrode disposed on the substrate. The reflecting electrode comprises a first recessed portion, and the inner wall of the first recessed portion is provided with at least two reflective surfaces that are connected and have different inclinations.

### CROSS REFERENCE TO RELATED APPLICATIONS

The present application is a Continuation Application of PCT Application No. PCT/CN2018/114610 filed on Nov. 8, 2018, which claims the benefit of Chinese Patent Application No. 201821630183.5, filed on Oct. 8, 2018, which is incorporated herein by reference in its entirety.

### FIELD OF THE DISCLOSURE

The present application relates to the technical field of a display, and in particular, to an array substrate, a display panel, and a display.

### BACKGROUND OF THE DISCLOSURE

At present, the liquid crystal displays generally have a transmissive type liquid crystal display, a reflective liquid crystal display, and a semi-transmissive liquid crystal display. Among which the transmissive type liquid crystal display uses a backlight on the back of the picture as a light source for display, the reflective liquid crystal display uses external light as a light source for display, and the semi-transmissive liquid crystal display uses both as a light source for display. Different liquid crystal displays can be selected according to different characteristics of the light source under different environments. For example, a reflective liquid crystal display can be used in sufficient light scenes, a transmissive type liquid crystal display can be used in low light scenes, and the semi-transmissive liquid crystal display can be used in scenes with illumination changes.

However, in the conventional liquid crystal display, the surface of the reflecting electrode is flat, and the reflected light is brighter only in a specific direction, resulting in a narrow range of viewing angles of the display.

### SUMMARY OF THE DISCLOSURE

The main object of the present application is to provide an array substrate designed to increase the range of viewing angles displayed by the display and the displayed lightness.

To achieve the above object, the present application proposes an array substrate including:

a substrate; and

a reflecting electrode disposed on the substrate. The reflecting electrode includes a first recessed portion, and the inner wall of the first recessed portion is provided with at least two reflective surfaces that are connected and have different inclinations.

Optionally, the first recessed portion has an aperture, and an inclination of the reflective surface is arranged as reducing from adjacent to an edge of the aperture toward a distance away from an edge of the aperture.

Optionally, each of the reflective surfaces are flat surfaces with different inclinations.

Optionally, at least one of the reflective surfaces is a flat surface and at least one of the reflective surfaces is a cambered surface.

Optionally, a reflective surface connected to an edge of the aperture is defined as a first reflective surface, and a reflective surface connected to the first reflective surface is defined as a second reflective surface. The first reflective surface is a flat surface, and the second reflective surface is a cambered surface.

Optionally, the array substrate includes a light transmissive pixel electrode layer disposed on the substrate, a portion of the pixel electrode layer forms a transmission electrode, and another portion of the pixel electrode layer is covered with a reflecting layer to form the reflecting electrode, and the reflecting layer is provided with the first recessed portion.

Optionally, a surface of the reflecting layer is recessed to form the first recessed portion.

Optionally, a surface of the pixel electrode layer covered with the reflecting layer is provided with a protrusion portion for molding a second recessed portion. The protrusion portion protrudes from a surface of the transmission electrode opposite to the pixel electrode layer, and the reflecting layer covers the second recessed portion to form a first recessed portion of the reflecting electrode.

Optionally, a top portion of the protrusion portion is provided with a flat portion, and the reflecting layer covers the flat portion and the second recessed portion.

Optionally, the array substrate further includes:

a gate disposed on the substrate;

a gate insulator layer covering the gate;

an active layer disposed on the gate insulator layer and connected to the pixel electrode layer; and

a source disposed on the active layer.

Further, to achieve the above object, the present application also provides a display panel, the display panel includes an array substrate including:

a substrate; and

a reflecting electrode formed on the substrate. The reflecting electrode includes a first recessed portion, the inner wall of the first recessed portion is provided with at least two reflective surfaces that are connected and have different inclinations.

Optionally, the display panel further includes a color film substrate and a liquid crystal layer disposed between the array substrate and the color film substrate.

Optionally, the first recessed portion has an aperture, and an inclination of the reflective surface is arranged as reducing from adjacent to an edge of the aperture toward a distance away from an edge of the aperture.

Optionally, each of the reflective surfaces are flat surfaces with different inclinations.

Optionally, a reflective surface connected to an edge of the aperture is defined as a first reflective surface, and a reflective surface connected to the first reflective surface is defined as a second reflective surface. The first reflective surface is a flat surface, and the second reflective surface is a cambered surface.

Further, to achieve the above object, the present application also provides a display, the display includes a display panel, the display panel includes an array substrate including:

a substrate; and

a reflecting electrode formed on the substrate. The reflecting electrode includes a first recessed portion, the inner wall of the first recessed portion is provided with at least two reflective surfaces that are connected and have different inclinations.

Optionally, the display panel further includes a color film substrate and a liquid crystal layer disposed between the array substrate and the color film substrate.

Optionally, the first recessed portion has an aperture, and an inclination of the reflective surface is arranged as reducing from adjacent to an edge of the aperture toward a distance away from an edge of the aperture.

Optionally, each of the reflective surfaces are flat surfaces with different inclinations.

Optionally, a reflective surface connected to an edge of the aperture is defined as a first reflective surface, and a reflective surface connected to the first reflective surface is defined as a second reflective surface. The first reflective surface is a flat surface, and the second reflective surface is a cambered surface.

The technical schemes of the present application provide a first recessed portion connected to at least two reflective surfaces with different inclinations on a reflecting electrode of the array substrate of the display. Each reflective surface can reflect the light incoming from the front light source or the external natural light in different directions, so that the display lightness of the display picture is increased, and the reflected light can be reflected in different directions to increase the range of viewing angles when images are displayed by the display, so that the user can obtain a better display picture when viewing the display in different directions, and improve the display effect of the display.

### BRIEF DESCRIPTION OF THE DRAWINGS

In order to illustrate the technical schemes in the embodiments of the present application or in the prior art more clearly, the drawings which are required to be used in the description of the embodiments or the prior art are briefly described below. It is obvious that the drawings described below are only some embodiments of the present application. It is apparent to those of ordinary skill in the art that other drawings may be obtained based on the structures shown in accompanying drawings without inventive effort.

FIG. 1 is a partial structural sectional view of an embodiment of an array substrate of the present application;

FIG. 2 is a partial structural sectional view of another embodiment of an array substrate of the present application.

### DESCRIPTION OF THE REFERENCE NUMERALS

| Reference | | Reference | |
|---|---|---|---|
| numeral | Name | numeral | Name |
| 100 | substrate | 210 | first recessed portion |
| 200 | reflecting electrode | 211 | reflective surface |
| 300 | pixel electrode layer | 400 | transmission electrode |
| 310 | protrusion portion | 320 | second recessed portion |
| 500 | reflecting layer | 600 | gate |
| 700 | gate insulator layer | 800 | active layer |
| 900 | Source | | |

With reference to the drawings, the implement of the object, features and advantages of the present application will be further illustrated in conjunction with embodiments.

### DETAILED DESCRIPTION OF THE EMBODIMENTS

The technical schemes of embodiments of the present disclosure will be clearly and completely described in the following with reference to the accompanying drawings. It is obvious that the embodiments to be described are only a part rather than all of the embodiments of the present disclosure. Based on the embodiments of the present application, all the other embodiments obtained by that of ordinary skill in the art without inventive effort are within the scope of the present application.

It should be noted that all directional indications (such as up, down, left, right, front, back, . . . ) in the embodiments of the present application are only used to explain the relative positional relationship, motion situation and the like between components in a certain posture (as shown in the drawings), if the specific posture changes, the directional indication shall also change accordingly.

In addition, the descriptions of “first”, “second” and the like in the present application are used for the purpose of description only, and are not to be construed as indicating or implying their relative importance or implicitly indicating the number of technical features indicated. Therefore, the characteristics indicated by the “first”, the “second” can express or impliedly include at least one of the characteristics. In addition, the technical schemes between the various embodiments may be combined with each other, provided that those skilled in the art can implement it, and when the combination of the technical schemes is contradictory or impossible to implement, it should be considered that the combination of these technical schemes does not exist, nor is it within the scope of protection required by this application.

The main schemes of embodiments of the present invention is to provide an array substrate having the following structures: the array substrate includes a substrate 100 and a reflecting electrode 200 disposed on the substrate 100, wherein the reflecting electrode 200 includes a first recessed portion 210, the inner wall of the first recessed portion 210 is provided with at least two reflective surfaces 211 that are connected and have different inclinations.

Since the surface of the reflecting electrode 200 in the display is generally flat, the reflected light is brighter only in a specific direction, resulting in a narrow range of viewing angles of the display.

The present invention provides a scheme for providing a first recessed portion 210 connected to at least two reflective surfaces 211 with different inclinations on a reflecting electrode 200 of the array substrate of the display, so that the display lightness of the display picture is increased to increase the range of viewing angles when images are displayed by the display, to facilitate the user to obtain a better display picture when viewing the display in different directions, and improve the display effect of the display.

The present application proposes an array substrate.

In the embodiment of the present application, the array substrate is applied to the display panel of the display, and in particular, to the display panel of the liquid crystal display.

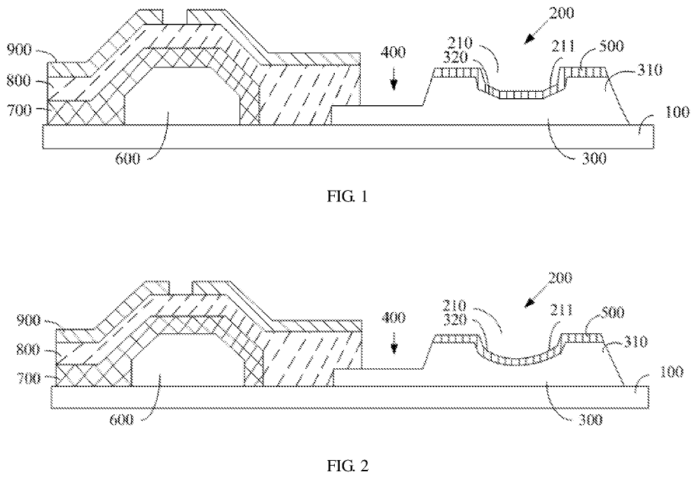

As shown in FIGS. 1 to 2, the array substrate includes a substrate 100, a reflecting electrode 200 disposed on the substrate 100, a gate line, a source line, and a thin film transistor. A plurality of gate lines and a plurality of source lines are disposed crosswise to form a pixel area of the display panel. The pixel area includes a plurality of pixel units, and each of the pixel units is provided with a thin film transistor and a reflecting electrode 200 on the substrate 100 respectively.

Among which the reflecting electrode 200 includes a first recessed portion 210, the inner wall of the first recessed portion 210 is provided with at least two reflective surfaces 211 that are connected and have different inclinations. The reflecting electrode 200 made of a material having good reflection characteristics can be used on the substrate 100, and the light of the front light source or the external natural light is reflected by the reflecting electrode 200 to realize the picture display. The inner wall of the first recessed portion 210 may be specifically spliced by at least two reflective surfaces 211 with different inclinations. The inner wall of the first recessed portion 210 may reflect incident lights in different directions due to the reflective surfaces 211 having different inclinations and may cause the light incoming in the same direction to form incident lights in different directions. The inclination is an included angle formed between the inner wall of the first recessed portion 210 and the substrate 100. In each of the pixel units, the first recessed portion 210 on the reflecting electrode 200 may be provided with one or more as needed.

The reflecting electrode 200 is specifically an electrode layer formed on the substrate 100. The electrode layer has first and second surfaces disposed oppositely. The first surface is bonded to the substrate 100, and the second surface may recess toward the substrate 100 to form the first recessed portion 210 described above. In addition, the second surface is provided with at least two protrusions arranged apart from each other, and the raised surface and the second surface enclose to form the first protrusion portion described above. Further, the protrusion provided on the second surface may be an annular protrusion, and the inner surface of the annular protrusion and the second surface enclose to form the first protrusion described above. Among which the second surface is a reflective surface that reflects incident lights.

The technical schemes of the present application provides a first recessed portion 210 connected to at least two reflective surfaces 211 with different inclinations on a reflecting electrode 200 of the array substrate of the display. Each reflective surface 211 can reflect the light incoming from the front light source or the external natural light in different directions, so that the display lightness of the display picture is increased, and the reflected light can be reflected in different directions to increase the range of viewing angles when images are displayed by the display, so that the user can obtain a better display picture when viewing the display in different directions, and improve the display effect of the display.

Among which the first recessed portion 210 has an aperture, and an inclination of the reflective surface 211 is arranged as reducing from adjacent to an edge of the aperture toward a distance away from an edge of the aperture. The side of the first recessed portion 210 facing away from the substrate 100 has an aperture, and the further the reflective surface 211 is away from the edge of the aperture of the first recessed portion 210, the smaller the inclination of the reflective surface 211 will be. The inclination of the reflective surface 211 connected to or near the edge of the aperture is greater than that of the reflective surface 211 located in or near the middle of the first recessed portion 210, wherein the reflective surface 211 located in the middle of the first recessed portion 210 may be 0 degree. Since the inclination of the reflective surface 211 near the edge of the aperture is smaller than that of the reflective surface 211 near the middle of the first recessed portion 210, a protrusion facing toward the aperture will be formed at the connection between the adjacent reflective surface 211 with a larger inclination and the reflective surface 211 with a smaller inclination. The protrusion may block a part of the reflected light formed on the reflective surface 211 in the middle of the first recessed portion 210 from causing the nonuniformity of lightness of the display picture. When the inclination of the reflective surface 211 near the edge of the aperture is larger than that of the reflective surface 211 near the middle of the first recessed portion 210, an indentation facing away from the aperture will be formed at the connection between the adjacent reflective surface 211 with a larger inclination and the reflective surface 211 with a smaller inclination, and will not block the reflected light. Therefore, the reflective surface 211 is disposed in accordance with the above distribution, which is advantageous for ensuring uniform and effective reflection of light in the first recessed portion 210.

The inclination of the inner wall of the first recessed portion 210 on the same reflective surface 211 may be same or inconsistent. When the inclinations in the same reflective surface 211 are inconsistent, the inclination on different positions of the reflective surface 211 gradually decreases from adjacent the edge of the aperture toward away from the edge of the aperture. Specifically, as shown in FIG. 1, each of the reflective surfaces 211 may be specifically a flat surface with different inclinations. Since the requirements for the molding process of the flat electrode surface is lower than those of the curved surface, splicing the inner wall of the first recessed portion 210 by arranging the flat surfaces having different inclinations is advantageous for shortening the manufacturing process of the array substrate and ensuring the molding quality of the reflecting electrode 200.

In addition, as shown in FIG. 2, the reflective surface 211 may also be disposed such that at least one reflective surface 211 is a flat surface and at least one reflecting surface 211 is a cambered surface. Among which the cambered surface can be disposed to directly form into a continuous reflective surface 211 having different inclinations without the need of splicing flat surfaces with different inclinations, thereby avoiding the defect that the light cannot be reflect at the connection of the reflective surface 211, which is beneficial to improving the uniform and effective reflection of the light in the first recessed portion 210.

Specifically, a reflective surface 211 connected to an edge of the aperture is defined as a first reflective surface, and a reflective surface 211 connected to the first reflective surface is defined as a second reflective surface. The first reflective surface is a flat surface, and the second reflective surface is a cambered surface. Among which, when the first recessed portion 210 is formed by the protrusions arranged apart from each other, the first reflective surface is specifically a surface of the first recessed portion 210 described above enclosed and formed by the protrusion, and the number of the first reflective surfaces coincides with the number of the protrusions. When the first recessed portion 210 is formed by the annular protrusion or the indentation of the reflective surface of the electrode layer, the first reflective surface is a slope connected to the edge of the aperture. An inner wall of the first recessed portion 210 is spliced by the second reflective surface and the first reflective surface. The different positions of the second reflective surface have different inclinations, and the inclination of the cambered surface is the included angle between the tangent of a certain point on the cambered surface and the substrate 100. The inclination in the middle of the second reflective surface is smaller than that of the edge of the second reflective surface, and the inclination of the first reflective surface is greater than that of any of the tangents of the second reflective surface. In the above manner, the first reflective surface connected to the edge of the aperture is disposed as a plat surface, and the second reflective surface located in the middle of the first recessed portion 210 and connected to the first reflective surface is disposed as a cambered surface, which is beneficial to obtain a wide range of viewing angles with a minimum of the reflective surface 211 by the cambered surface in the middle of the first recessed portion 210 in the limited spatial position of the pixel unit. Among which the first reflective surface serves as a transition portion between the second reflective surface and the edge of the aperture, which is beneficial to the molding quality control of the second reflective surface during molding.

Specifically, the array substrate includes a light transmissive pixel electrode layer 300 disposed on the substrate 100, a portion of the pixel electrode layer 300 forms a transmission electrode 400, and another portion of the pixel electrode layer 300 is covered with a reflecting layer 500 to form the reflecting electrode 200, and the reflecting layer 500 is provided with the first recessed portion 210. The pixel electrode layer 300 is formed of a light transmissive electrode material, and the reflecting layer 500 is made of a material having excellent reflection characteristics. A portion of the pixel electrode layer 300 is covered with the reflecting layer 500, so that the light is not transmitted through the pixel electrode layer 300, but reflected on the reflecting layer 500 to realize the image display. A portion of the pixel electrode layer 300 that is not covered with the reflecting layer 500 can transmit through light to images realize the image display. Therefore, the portion of the pixel electrode layer 300 without being covered with the reflecting layer 500 forms the transmission electrode 400 on the array substrate, and the portion of the partial pixel electrode layer 300 covered with the reflecting layer 500 forms the reflecting electrode 200 on the array substrate. Specifically, the light transmissive pixel electrode layer 300 may be made of ITO (Indium Tin Oxides, N-type oxide semiconductor—indium tin oxide), and the reflecting layer 500 may be made of aluminum.

A surface of the pixel electrode layer 300 covered with the reflecting layer 500 is provided with a protrusion portion 310 for molding a second recessed portion 320. The protrusion portion 310 protrudes from a surface of the transmission electrode 400 opposite to the pixel electrode layer 300, and the reflecting layer 500 covers the second recessed portion 320 to form a first recessed portion 210 of the reflecting electrode 200. The pixel electrode layer 300 has first and second flat surfaces disposed oppositely. The first flat surface is bonded to the substrate 100, and the second flat surface may be provided with a protrusion portion 310 for molding the second recessed portion 320. The protrusions disposed opposite to each other on the flat surface may also be an annular protrusion, and the inner surface of the protrusion 310 and the second flat surface enclose to form the second recessed portion 320. The reflecting layer 500 is provided with the first recessed portion 210. Specifically, the pixel electrode layer 300 may have a flat structure as a whole, and the first recessed portion 210 may be recessed to form only on the surface of the reflecting layer 500. In order to reduce the overall thickness of the reflecting electrode 200, the position of the pixel electrode layer 300 covered with the emission layer may be provided with a second recessed portion 320, and the reflecting layer 500 covers the second recessed portion 320 to form the first recessed portion 210 described above, and the reflecting layer 500 may specifically cover the layered structure having a uniform thickness on the second recessed portion 320. The position of the liquid crystal layer of the display panel to which the array substrate is applied corresponding to the transmission electrode 400 is a transmissive area, and the position corresponding to the reflecting electrode 200 is a reflective area. In the above manner, the thickness of the liquid crystal layer in the transmissive area can be made larger than the thickness in the reflective area, which is beneficial to adjust the optical path difference of the transmitted light of the liquid crystal layer that has passed through the transmissive area and the reflected light of the liquid crystal layer that has passed through the reflective area.

Among which the top portion of the protrusion portion 310 may be specifically provided with a flat portion, and the reflecting layer 500 covers the flat portion and the second protrusion portion 320 at the same time. The provision of the flat portion is beneficial to increase the adhesion between the reflecting layer 500 and the pixel electrode layer 300.

Specifically, the array substrate further includes a gate 600, a gate insulator layer 700, an active layer 800, and a source 900. Among which the gate electrode 600 is disposed on the substrate 100, the gate insulator layer 700 is disposed on the gate electrode 600, the active layer 800 is disposed on the gate insulator layer 700, and is connected to the pixel electrode layer 300, and the source 900 is disposed on the active layer 800. The above structure of the array substrate forms a thin film transistor, and each pixel unit on the array substrate is provided with a thin film transistor, and the gate 600 of each thin film transistor is connected to a gate line on the array substrate, and the source of each thin film transistor 900 is connected to the source line on the array substrate. Among which the source 900 is in contact with the active layer 800, and the active layer 800 is connected to the pixel electrode layer 300, which can avoid damage to the metal oxide semiconductor layer when the source/drain metal electrode is formed, while directly in contact with the metal oxide semiconductor layer using the pixel electrode layer 300, without the need for the drain electrode metal which greatly reduces the resistance between the metal oxide semiconductor layer and the pixel electrode layer 300, and greatly improves the display characteristics of the display panel.

At the time of molding, a transparent electrode which is not patterned may be formed on the substrate 100, and the pixel electrode layer 300 described above is etched on the transparent electrode by half-tone exposure. Specifically, the etching of the pixel electrode layer 300 is performed by using a half-tone mask having different optical transmittances. The half-tone mask specifically includes a light shielding portion and a light transmitting portion, and the optical transmittance of the light shielding portion is 0, and the optical transmission of the light transmitting portion is greater than that of the semi-transmissive portion. The distribution of the light transmitting portion and the light shielding portion on the half-tone mask depends on the distribution position of the pixel electrode layer 300 on the substrate 100 and the distribution position of the transmission electrode 400 and the reflecting electrode 200 formed by the pixel electrode layer 300, and the shape structure of the projection electrode and reflecting electrode 200 are specifically set. At the time of exposure, the thickness of the transparent electrode corresponding to the light shielding portion does not change, and the thickness of the transparent electrode corresponding to the light transmitting portion is gradually thinned during the exposure. Specifically, a plurality of light transmitting portions having different optical transmittances may be specifically provided to form the structure of the pixel electrode layer 300 described above. Specifically, the greater the etching depth of the transparent electrode, the higher the light projection rate of the light transmitting portion at the corresponding position will be.

At the time of exposure, the half-tone mask is arranged apart from the layered transparent electrodes. Specifically, a portion of the pixel electrode layer 300 formed correspondingly by the first light transmitting portion may be used as the transmission electrode 400 and the thickness of the transparent electrode becomes small under the action of the first light transmitting portion but a layered structure with a certain thickness still retains to form the transmission electrode 400; a top portion of the protrusion portion 310 described above is formed correspondingly by a light shielding portion connected to the first light transmitting portion; the second protrusion portion 320 described above is formed correspondingly by the second light transmitting portion connected to the light shielding portion, wherein the optical transmittance of the first light transmitting portion is greater than that of the second light transmitting portion. The optical transmittance in the second light transmitting portion can be adapted to the reflective surface 211 with different inclinations to change periodically or continuously correspondingly. If a thin film transistor is disposed on the substrate 100 or a position where no layered structure is provided, the third transparent portion with the highest optical transmittance may be formed by exposure. The layered transparent electrode exposed by the third light transmitting portion can etch the transparent electrode completely without remaining on the substrate 100. After the pixel electrode layer 300 is formed, a reflecting layer 500 having a uniform thickness is formed on the top portion of the protrusion portion 310 and the inner portion of the second protrusion portion 320 so that a portion of the pixel electrode layer 300 and the reflecting layer 500 are bonded to form the reflecting electrode 200.

Further, after the pixel electrode layer 300 is formed, the gate electrode 600, the gate insulator layer 700, the active layer 800, and the source electrode 900 may be sequentially formed on the substrate 100 by a half-tone exposure method. The pixel electrode layer 300, the gate electrode 600, the gate insulator layer 700, the active layer 800, and the source layer 900 with different shapes on the array substrate and distributed on different positions on the array substrate is formed by using a half-tone mask, thereby facilitating the simplification of the manufacturing process of the array substrate, improving the production efficiency of the array substrate, the display panel to which the array substrate is applied, and the display provided with the array substrate.

The present application further proposes a display panel including an array substrate, a color film substrate, and a liquid crystal layer disposed between the array substrate and the color film substrate. Among which the array substrate includes a substrate 100 and a reflecting electrode 200 formed on the substrate 100. The reflecting electrode 200 includes a first recessed portion 210, the inner wall of the first recessed portion 210 is provided with at least two reflective surfaces 211 that are connected and have different inclinations. The specific structure of the array substrate can be understood with reference to the foregoing embodiments. Since the display panel adopts all the technical schemes of all the above embodiments, it has at least all the beneficial effects brought about by the technical schemes of the above embodiments, and details are not described herein again.

In addition, the present application also proposes a display, which can be a liquid crystal display that can reflect light, and can be specifically a total reflective liquid crystal display or a semi-transmissive liquid crystal display. The display includes a display panel. The display panel includes an array substrate, a color film substrate, and a liquid crystal layer disposed between the array substrate and the color film substrate. Among which the array substrate includes a substrate 100 and a reflecting electrode 200 formed on the substrate 100. The reflecting electrode 200 includes a first recessed portion 210, the inner wall of the first recessed portion 210 is provided with at least two reflective surfaces 211 that are connected and have different inclinations. The specific structure of the array substrate is referred to the above embodiments. Since the display adopts all the technical schemes of all the above embodiments, it has at least all the beneficial effects brought about by the technical schemes of the above embodiments, and details are not described herein again.

The above mentioned is only the alternative embodiment of the present invention, which does not limit the patent scope of the present invention, and any equivalent structure transformation made by using the specification and the drawings of the present invention or direct/indirect applications in other related technical fields should be contained in the scope of patent protection in a similar way.

What is claimed is:

1. An array substrate, wherein comprising:
a substrate; and
a reflecting electrode disposed on the substrate; the reflecting electrode comprises a first recessed portion, and the inner wall of the first recessed portion is provided with at least two reflective surfaces that are connected and have different inclinations.

2. The array substrate according to claim 1, wherein the first recessed portion has an aperture, and an inclination of the reflective surface is arranged as reducing from adjacent to an edge of the aperture toward a distance away from an edge of the aperture.

3. The array substrate according to claim 2, wherein each of the reflective surfaces are flat surfaces with different inclinations.

4. The array substrate according to claim 2, wherein at least one of the reflective surfaces is a flat surface and at least one of the reflective surfaces is a cambered surface.

5. The array substrate according to claim 4, wherein a reflective surface connected to an edge of the aperture is defined as a first reflective surface, and a reflective surface connected to the first reflective surface is defined as a second reflective surface. The first reflective surface is a flat surface, and the second reflective surface is a cambered surface.

6. The array substrate according to claim 2, wherein the array substrate comprises a light transmissive pixel electrode layer disposed on the substrate, a portion of the pixel electrode layer forms a transmission electrode, and another portion of the pixel electrode layer is covered with a reflecting layer to form a reflecting electrode, and the reflecting layer is provided with the first recessed portion.

7. The array substrate according to claim 6, wherein a surface of the reflecting layer is recessed to form the first recessed portion.

8. The array substrate according to claim 6, wherein a surface of the pixel electrode layer covered with the reflecting layer is provided with a protrusion portion for molding a second recessed portion. The protrusion portion protrudes from a surface of the transmission electrode opposite to the pixel electrode layer, and the reflecting layer covers the second recessed portion to form a first recessed portion of the reflecting electrode.

9. The array substrate according to claim 8, wherein a top portion of the protrusion portion is provided with a flat portion, and the reflecting layer covers the flat portion and the second recessed portion.

10. The array substrate according to claim 6, wherein the array substrate further comprises:
a gate disposed on the substrate;
a gate insulator layer covering the gate;
an active layer disposed on the gate insulator layer and connected to the pixel electrode layer; and
a source disposed on the active layer.

11. A display panel, wherein the display panel comprises an array substrate comprising a substrate and a reflecting electrode disposed on the substrate. The reflecting electrode comprises a first recessed portion, the inner wall of which is provided with at least two reflective surfaces that are connected and have different inclinations.

12. The display panel according to claim 11, wherein the display panel further comprises a color film substrate and a liquid crystal layer disposed between the array substrate and the color film substrate.

13. The display panel according to claim 12, wherein the first recessed portion has an aperture, and an inclination of the reflective surface is arranged as reducing from adjacent to an edge of the aperture toward a distance away from an edge of the aperture.

14. The display panel according to claim 13, wherein each of the reflective surfaces are flat surfaces with different inclinations.

15. The display panel according to claim 13, wherein a reflective surface connected to an edge of the aperture is defined as a first reflective surface, and a reflective surface connected to the first reflective surface is defined as a second reflective surface. The first reflective surface is a flat surface, and the second reflective surface is a cambered surface.

16. A display, wherein the display comprises a display panel comprising an array substrate, the array substrate comprises a substrate and a reflecting electrode disposed on the substrate. The reflecting electrode comprises a first recessed portion, the inner wall of which is provided with at least two reflective surfaces that are connected and have different inclinations.

17. The display according to claim 16, wherein the display panel further comprises a color film substrate and a liquid crystal layer disposed between the array substrate and the color film substrate.

18. The display according to claim 17, wherein the first recessed portion has an aperture, and an inclination of the reflective surface is arranged as reducing from adjacent to an edge of the aperture toward a distance away from an edge of the aperture.

19. The display according to claim 18, wherein each of the reflective surfaces are flat surfaces with different inclinations.

20. The display according to claim 18, wherein a reflective surface connected to an edge of the aperture is defined as a first reflective surface, and a reflective surface connected to the first reflective surface is defined as a second reflective surface. The first reflective surface is a flat surface, and the second reflective surface is a cambered surface.
